(19) United States
(12) Patent Application Publication
(10) Pub. No.: US 2021/0140647 A1
(43) Pub. Date: May 13, 2021

(54) ASSEMBLY FOR DETECTING OPERATING PARAMETERS WITHIN AN OVEN CAVITY

(71) Applicant: ELECTROLUX APPLIANCES AKTIEBOLAG, Stockholm (SE)

(72) Inventors: Klaus SCHLÖTTERER-FRATOIANNI, Rothenberg ob der Tauber (DE); Arnd HOFMANN, Rothenberg ob der Tauber (DE)

(21) Appl. No.: 16/616,662

(22) PCT Filed: May 15, 2018
(86) PCT No.: PCT/EP2018/062635

§ 371 Date: Nov. 25, 2019

(30) Foreign Application Priority Data
Jun. 7, 2017 (EP) 17174764.5

(51) Int. Cl. F24C 7/08; F24C 15/20

(52) U.S. Cl. CPC F24C 7/085; A21B 3/04; F24C 15/2007

(57) ABSTRACT

An assembly (10) for detecting operating parameters within an oven cavity (22) comprises: *(a) a housing (12); *(b) a sensor (14, 64) disposed within the housing (12); *(c) an air inlet (16) for feeding air into the housing (12); and *(d) an air outlet (18, 38) through which air can leave the housing (12).

The present invention relates to an assembly for detecting operating parameters within an oven cavity.

Modern cooking ovens often are equipped with sensors to detect operating parameters within the oven cavity, such as temperature and/or humidity within the oven cavity. The oven also may be equipped with optical sensors, such as an imaging system, to automatically detect or monitor the load within the oven cavity, so as to control operating parameters of the oven in dependency of the load detected or of the cooking progress, such as a degree of change in size or color of the food items being processed.

Evidently, in order to be able to detect the parameter or parameters to be monitored, the sensors have to be placed at a location that allows picking up the signals that are representative of the parameter to be monitored, which necessitates that the one or more sensors have to be arranged in close proximity to the oven cavity. In case that the sensor is an optical sensor, the sensor has to be located in eye-sight of the oven cavity. Due to the harsh conditions prevailing in an oven, such as high temperature and high humidity, it was suggested in the prior art to locate the sensor in a chamber that is separate from the oven cavity, such as within an air channel that is used to vent air from within the oven cavity to the exterior. A problem with such systems, as they were suggested for example in DE10 2004 210 673 A1, DE10 2004 056 839 A1 or DE 10 2006 058 617 B3, is that the sensor necessarily has to be positioned remote from the oven cavity, which for an optical sensor is disadvantageous due to the limited field of view. Furthermore, when the sensor is located within a vent channel, so as to be cooled by air that is removed from within the oven cavity, not only does the positioning of the sensor within the vent channel interfere with, and thus deteriorate, the venting action, but also is the sensor cooling rather limited, given that the air that leaves the oven cavity is of high temperature.

It is an object of the present invention to provide for an assembly for detecting operating parameters within an oven cavity which reliably allows monitoring the respective operating parameter to be monitored, but which at the same time is effectively protected against the harsh environment that may prevail within the oven cavity during a cooking process.

In accordance with the present invention the above object is solved by an assembly for detecting operating parameters within an oven cavity, which assembly comprises a housing, a sensor disposed within the housing, an air inlet for feeding air into the housing, and an air outlet through which air can leave the housing.

Instead of providing for a sensor that is to be located in a region of the oven, where there are less harsh operating conditions as compared to those prevailing within the oven cavity, as it was suggested in the prior art, the present invention provides for a sensor assembly in which the sensor has its own cooling system, by arranging the sensor within a housing through which air can be fed. In this manner it is made possible to arrange temperature-sensitive sensor systems, such as imaging systems or humidity sensors, in direct ambience of an oven cavity.

In this manner, more direct and thus precise information can be obtained with respect to the state of the food product under treatment, the degree of preparation of the food product being processed, the state of the oven muffle and the oven cavity including any components therein. By evaluating the monitored parameters, potentially detrimental or even hazardous situations can be prevented, such as overheating of food or of oven components. Apart from providing for prevention against abnormal or abusive operation of the appliance, continuously monitoring respective parameters also allows for automation of the food treatment, wherein the appliance automatically adjusts operation parameters in dependency of the monitored parameters.

Preferred embodiments of the present invention are defined in the dependent claims.

Thus, in order to facilitate removal of heat from the sensor, preferably a heatsink is disposed within the housing in contact with the sensor. The heatsink preferably is an element having a large thermal capacity, and further preferably is designed to have a large surface area so as to facilitate heat exchange with its surroundings, so that the heat sink acts as a dissipator for the heat that has been captured.

To improve the heat transfer between the heatsink and the sensor, preferably a thermal interface material is disposed between the heatsink and the sensor, such as thermal grease, thermal glue or a thermal adhesive, which improves the thermal conductivity between the heatsink and the sensor by eliminating gaps or spaces between these components.

The sensor can comprise any sensor, or combination of sensors, suitable to detect signals characteristic for a parameter to be monitored. In particular, the sensor may comprise at least one of an optical sensor, an imaging system, a humidity sensor, a temperature sensor, a gas sensor, a sound sensor, and a chemical sensor, or the like. Thus various signals can be picked up to monitor the cooking progress. Amongst optical parameters to be monitored are to be named the amount and distribution of food items loaded into the oven, a change in color of food items processed such as the degree of browning of an article being roasted or baked, a change in shape, such as the rising of a dough, and the like. While temperature and humidity within the oven cavity are important parameters to be monitored by respective sensors, sound sensors can be employed for example for boiling detection, or for detection of certain sound events such as the popping sound when preparing popcorn. Vapor sensors, gas sensors or other chemical sensors can be employed to detect the generation of various substances.

In preferred embodiments, the housing comprises a cover which covers a receptive region of the sensor element but which is permeable for the physical or chemical parameter to be detected by the sensor.

Thus, when the sensor is a humidity sensor, the cover preferably comprises a membrane, such as a PTFE membrane, which is permeable for water vapor, but which protects the receptive region of the sensor from water and dust.

When the sensor is an optical sensor, the cover preferably comprises a transparent element, such as a cover made of glass or transparent plastic, wherein in further preferred embodiments the transparent element is designed as an optical filter and/or lens, so as to further enhance and optimize the optical transmission to the sensor.

In order to avoid rapid warming of the sensor housing, the housing or at least parts thereof are made from a material having a thermal conductivity at standard conditions (i.e. atmospheric pressure and a temperature of about 293 K) of less than 10 W/m*K, preferable of less than 1 W/m*K, which can be realized for example with certain heat resistant plastic materials, such as PTFE.

To provide for further variability in mounting the sensor assembly to elements of an oven cavity, the assembly can comprise a housing support for mounting the housing to a wall of the oven cavity, which housing support can be designed not only to facilitate mounting of the sensor assembly, but also to provide for further thermal protection of the assembly, such as by making the housing support of a material which has a lower thermal conductivity than the housing.

The present invention further is an oven with an oven cavity and an assembly as it is described above, wherein the oven comprises means for generating a forced air flow which is directed to the air inlet, and wherein the assembly is located within the oven cavity. Due to the fact that the assembly comprises a housing within which there is disposed the sensor and which is designed such that an air flow can be passed through the housing so as to cool the sensor, the assembly can be located within the oven cavity as such where it can be used for direct measurements of parameters to be monitored.

The air flow to be passed through the housing so as to cool the sensor can be generated either by a fan that is used to feed air into the oven cavity, wherein the air flow to the sensor assembly is diverted from the air volume passed into the cavity. In order to provide for cooling of the sensor assembly independent from the operation of the fan that is used to provide air into the oven cavity, preferably the oven is equipped with a dedicated fan that is used to provide air for cooling one or more sensor assemblies.

In a further embodiment, the present invention is an oven with an oven cavity and an assembly as it is described above, wherein the assembly is mounted to the exterior side of a wall of the oven cavity and communicates with the interior of the oven cavity through a region provided in the wall of the oven cavity which is permeable for the physical or chemical parameter to be detected by the sensor. Depending on the parameter to be detected, such permeable region can be simply an opening in the wall of the oven cavity, or a transparent element, a sound-transmissive element, a light-transmissive element, a membrane, and the like.

To reduce the number of parts, the housing can be formed in part by a deep drawn region in a wall of the oven cavity.

The air which is passed into the assembly housing for cooling of the sensor either can be expelled into the oven cavity, or can be used for further purposes, such as for the cooling of at least one further sensor assembly, for cooling an exterior wall of the assembly housing, or can be vented to the exterior of the oven.

Both, in embodiments in which the assembly is mounted to the exterior side of a wall of the oven cavity and communicates with the interior of the oven cavity through a permeable region in the wall of the oven cavity, but also in embodiments in which the assembly is mounted within the oven cavity and wherein the sensor assembly as such comprises a permeable cover, the air outlet advantageously comprises one or more outlet openings located in the perimeter of the cover, so as to provide for an air stream which protects the permeable region or the cover, respectively, from oven fumes, so as to prevent soiling for example by oil or soot particles contained in such fumes.

To further improve such protecting effect of the exiting air flow, the outlet openings are arranged such that the air is expelled in a turbulent flow, as may be attained for example by merging the exit flows leaving individual outlet openings, such as by providing for an inclination of the axis along which the air flows leave the outlet openings, or by orienting the outlet openings in a manner so as to provide for a swirling flow.

To further prevent heating of the assembly, an insulation layer can be provided at a wall of the housing which faces towards the oven cavity.

In embodiments of the present invention, elements of the assembly can be formed as an integral part so as to facilitate mounting of the assembly by reducing the number of elements to be assembled. Thus, for example a heat sink can be formed as an integral part of the housing.

Preferred embodiments of the present invention will be described by reference to the drawings in which:

FIG. 1 shows a sectional view of a first embodiment of a sensor assembly in accordance with the present invention;

FIG. 2 shows a sectional view of a second embodiment of a sensor assembly in accordance with the present invention;

FIG. 3 shows a sectional view of a third embodiment of a sensor assembly in accordance with the present invention;

FIG. 4 is a perspective view of the sensor assembly illustrated in FIG. 2;

FIG. 5 illustrates an exploded view of a sensor assembly in accordance with the present invention, wherein the sensor is an optical sensor; and

FIG. 6 illustrates an exploded view of a sensor assembly in accordance with the present invention, wherein the sensor is a humidity sensor.

FIG. 1 illustrates a sensor assembly made in accordance with the present invention. Sensor assembly 10 comprises a housing 12 in which there is located a sensor element 14, which in the embodiment shown in FIG. 1 comprises an imaging system having a camera. Housing 12 comprises an air inlet 16 for feeding air into the housing 12 and an air outlet 18 through which air can leave the housing 12 upon having passed over and along the sensor element 14 for cooling thereof, as is depicted in FIG. 1 by arrows. To further facilitate heat being withdrawn from sensor element 14, the sensor assembly 10 comprises a heat sink 20 which is mounted on the side of the sensor element 14 facing away from an oven cavity 22, which is formed by an oven muffle of which in FIG. 1 there only is shown a portion of an upper wall 24.

As shown in FIG. 1, sensor assembly 10 comprises an annular portion 26 protruding from a bottom wall 28 of housing 12, which is mounted within an opening 30 of the upper wall 24 of the oven muffle. To prevent oven fumes from entering the annular portion 26, there is provided a transparent element 32 which enables the sensor element 14 to monitor the interior of the oven cavity 22.

FIG. 2 shows a sensor assembly which differs from the one illustrated in FIG. 1 in that the air that is passed into the housing 12 via air inlet 16 is expelled into the oven cavity 22. To this end housing 12 comprises a wall 34 that closes the end of the housing 12 opposite air inlet 16, and further comprises an air outlet 36 at the bottom of annular portion 26. As is shown in further detail in the perspective view of FIG. 4, annular portion 26 can be designed as an annular channel, into which air leaving housing 12 enters via a plurality of openings 37 and from which the air is passed into the oven cavity 22 in an annular flow around transparent element 32 via a plurality of outlet openings 38.

In the embodiment illustrated in FIGS. 2 and 4, the sensor assembly 10 further is designed for use in an oven that in addition to a heating capability, such as by heating elements, hot air or steam, further provides for a microwave function. While the sensor assembly 10 is protected from oven fumes by the transparent element 32, in order to protect the sensor element 14 from microwaves there additionally is provided a metallic wall 39 having an aperture 40 in close proximity to the optical sensor element 14.

As can be best seen in FIG. 4, the heat sink 20 is provided with a plurality of fins 42 which provide for a large surface area of the heat sink 20 to thus improve the heat exchange with cooling air that is passed through the housing 12.

In FIG. 3 there is shown a variant of a sensor assembly 10 that is similar to the ones shown in FIGS. 1 and 2, but in which the air leaving housing 12 is expelled laterally from the annular portion 26, so as to be fed into the space between upper wall 24 of the oven muffle and bottom wall 28 of housing 12, so as to provide for additional cooling of housing 12 and further to provide for an insulating air layer between the upper wall 24 of the oven muffle and the bottom wall 28 of the assembly housing 12.

While in the embodiments shown in FIGS. 1 and 3 the air flow after cooling the sensor is used to provide for further cooling, either of another sensor as in the FIG. 1 embodiment, or another part of the same sensor assembly as in the FIG. 3 embodiment, the air leaving the sensor assembly also can be used to provide a dynamic air barrier, preferably by providing for a turbulent swirling flow, which prevents oven fumes or other dirt particles from reaching the active sensor area.

Whereas in the embodiments illustrated in FIGS. 1 to 4 at least a portion of the sensor assembly 10 is located behind a wall of the oven muffle, it is to be understood that similarly as is shown for the annular portion 26, also the entire bottom wall 28 could be in direct contact with the interior of the oven cavity 22, such as by arranging assembly 10 in an opening in a wall of the oven muffle (similarly as opening 30), the size of which corresponds to the size of the bottom wall 28. Furthermore, due to the cooling capacity of the sensor assembly also the entire sensor assembly 10 could be arranged within the interior 22 of the oven cavity, such as within a depression of a wall of the oven muffle, which depression may be formed as a deep drawn region of the oven muffle.

The sensor assembly suggested herein is capable of sufficiently cooling sensors for use within a baking oven, which further to having resistance heating elements may incorporate at least one other heating technology, such as steam generation or microwave generation, and which further may be provided with a pyrolytic cleaning capacity.

In FIG. 5 there is shown an exploded view of a further embodiment of a sensor assembly 10 in accordance with the present invention.

The sensor assembly 10 shown in FIG. 5 comprises a generally box shaped housing 12 which at one end comprises an integrally formed air inlet 16. Housing 12 which is open at its upper side comprises a bottom wall 28 in which there are provided a plurality of outlet openings 43 which are located to form a circle around a central opening 44. Within housing 12 there is located a sensor element 14, which in the embodiment depicted in Fig, 5 is designed as an optical sensor having a camera element 46 which in the assembled state is located above central opening 44. Above sensor element 14 there is shown a heat sink 20 which in the assembled state contacts sensor element 14 so as to withdraw heat from the sensor element. Similarly as the heat sink 20 shown in FIG. 4, also in the embodiment shown in FIG. 5 the heat sink 20 comprises a plurality of lamellas 42 so as to increase the surface area of heat sink 20 about a channel 48 through which air is passed during use of the sensor assembly. The opening at the upper side of housing 12 is closed by a lid 50, which further also could be formed as an integral part with the heat sink 20.

While so far the sensor assembly 10 shown in FIG. 5 is similar to the one shown in FIGS. 2 and 4, in the FIG. 5 embodiment there is provided a housing support 52 for mounting the sensor assembly to a wall of the oven cavity, either at the exterior side or at the interior side thereof. The housing support 52 is made of a temperature resistant material which preferably has a lower thermal conductivity than the housing 12 so as to provide for thermal protection thereof. Housing support 52 comprises at its upper side an annular wall 54 within which there is provided a receptacle (not shown in FIG. 5) for a transparent element 32, and which forms together with an annular element 56 an annular channel for air leaving outlet openings 28. Housing support 52 further comprises supports 58 and 60 for supporting the bottom wall 28 of housing 12. In order to provide for additional thermal insulation of housing 12, an insulation layer 62 is provided at the bottom wall 18 of housing 12.

In FIG. 6 there is shown a sensor assembly similar as the one shown in FIG. 5, wherein the assembly comprises a housing 12 that is mounted on a housing support 52. However, in the embodiment shown in FIG. 6, the assembly is designed for use with a humidity sensor 64. Furthermore, in contrast to the embodiment shown in FIG. 5, where the air used for cooling the sensor is expelled into the oven cavity, in the embodiment shown in FIG. 6 there is provided an air outlet 18 as is shown also in FIG. 1.

Correspondingly the bottom wall 18 of housing 12 has no air opening 28 as shown in FIG. 5, but only is provided with an opening 44 that is in alignment with the humidity sensor 64 as shown in FIG. 6. In order to protect humidity sensor 64 from contact with water droplets or other particles contained in the oven fumes, there is provided an annular element 66 which carries a membrane 68 that is permeable to water vapor. Element 70 shown in FIG. 6 is a connection ring for mounting humidity sensor 64 within housing 12.

### REFERENCE SIGNS

10 sensor assembly

12 housing

14 sensor element

16 air inlet

18 air outlet

20 heat sink

22 oven cavity

24 upper wall of oven muffle

26 annular portion

28 bottom wall of 12

30 opening in 24

32 transparent element

34 wall of 12

16 air outlet

37 openings

38 outlet openings

39 metallic wall

40 aperture

42 fins

43 outlet openings

44 central opening

46 camera element

48 channel

50 lid

52 housing support

54 annular wall

56 annular element

58 support

60 support

62 insulation layer

64 humidity sensor

66 annular element

68 membrane

70 connection ring

1. Assembly for detecting operating parameters within an oven cavity, the assembly comprising:
(a) a housing;
(b) a sensor arranged within the housing;
(c) an air inlet for feeding air into the housing; and
(d) an air outlet through which air can leave the housing.

2. The assembly of claim 1, further comprising:
a heatsink disposed within the housing in contact with the sensor.

3. The assembly of claim 2, further comprising:
a thermal interface material disposed between the heatsink and the sensor.

4. The assembly of claim 1, wherein the sensor comprises at least one of an optical sensor, an imaging system, a humidity sensor, a temperature sensor, a gas sensor, a sound sensor, and a chemical sensor.

5. The assembly of claim 1, further comprising a cover which covers a receptive region of the sensor but which is permeable for a physical or chemical parameter to be detected by the sensor.

6. The assembly of claim 5, wherein the sensor is a humidity sensor and the cover comprises a membrane which is permeable for water vapor.

7. The assembly of claim 5, wherein the sensor is an optical sensor and the cover comprises a transparent element.

8. The assembly of claim 7, wherein the transparent element is designed as an optical filter and/or lens.

9. The assembly of claim 1, wherein the housing or parts thereof are made from a material having a thermal conductivity at standard conditions of less than 10 W/m·K.

10. The assembly of claim 1, further comprising a housing support (52) for mounting the housing to a wall of the oven cavity.

11. The assembly of claim 10, wherein the housing support is made of a material having a lower thermal conductivity than the housing.

12. Oven with an oven cavity and the assembly of claim 1, the oven comprising means for generating a forced air flow which is directed to the air inlet, and wherein the assembly is located within the oven cavity.

13. Oven with an oven cavity and the assembly of claim 1, wherein the assembly is mounted to an exterior side of a wall of the oven cavity and communicates with an interior of the oven cavity through a region provided with the wall of the oven cavity which is permeable for a physical or chemical parameter to be detected by the sensor.

14. Oven of claim 12, wherein the housing is formed in part by a deep drawn region in a wall of the oven cavity.

15. Oven of claim 12, wherein the air outlet is located to expel air into the oven cavity.

16. Oven of claim 15, having an assembly as defined in claim 5, wherein the air outlet comprises one or more outlet openings located in a perimeter of the cover.

17. Oven of claim 12, wherein the air outlet is connected to a conduit to remove air from the assembly.

18. Oven of claim 12, wherein the air outlet is located in a wall of the housing so as to expel air to an exterior side of the housing.

19. Oven of claim 12, wherein said means for generating a forced air flow comprise a fan for feeding ambient air to the air inlet 16.

20. Oven of claim 12, further comprising an insulation layer at a wall of the housing facing towards the oven cavity.

21. An oven comprising an oven cavity for cooking food therein, and a sensor assembly, the sensor assembly being attached to or formed in part with a wall of the oven cavity and comprising a sensor housing and a sensor disposed within the sensor housing, said sensor being adapted to detect an operating parameter during a cooking operation within the oven cavity, at least a portion of said sensor housing and/or said oven cavity between said sensor and an interior of said cavity being transparent or permeable to the operating parameter to be detected by the sensor, said sensor housing further comprising an air inlet and an air outlet, means to generate a forced flow of air into said inlet and over said sensor so as to cool said sensor prior to being expelled from the sensor housing via said air outlet, the air outlet configured to discharge said flow of air in turbulent flow, said sensor housing being made of a material having a thermal conductivity less than 1 W/m-K at standard conditions of temperature and pressure, a heatsink in thermal communication with said sensor within the sensor housing and being effective to enhance thermal energy transfer from said sensor into said stream of cooling air passed through said sensor housing, and a layer of insulation at a wall of said housing facing toward the oven cavity.
